(19) United States
(12) Patent Application Publication
(10) Pub. No.: US 2005/0238446 A1
(43) Pub. Date: Oct. 27, 2005

(54) Drill press having an inspection structure

(75) Inventors: Eric Lo, Taichung County (TW); George Ku, Taichung County (TW)

Correspondence Address: BACON & THOMAS, PLLC, 625 SLATERS LANE, FOURTH FLOOR, ALEXANDRIA, VA, 22314, US

(73) Assignee: REXON CO., LTD., Taichung County (TW)

(21) Appl. No.: 10/832,391

(22) Filed: Apr. 27, 2004

(51) Int. Cl. B23B 47/16

(52) U.S. Cl. 408/128

(57) ABSTRACT

A drill press includes a base, a column, a table, a chuck, a drive member, a transmission unit, a safety guard, and an inspection structure. Thus, an operator can view and inspect the transmission unit mounted in the safety guard through the inspection structure to directly judge the rotation speed of the rotation shaft of the chuck by inspecting the engaging conditions of the belt wheels of the transmission unit without having to remove the safety guard to expose the transmission unit, thereby facilitating the operator manipulating the drill press and replacing the bits.

### BACKGROUND OF THE INVENTION

1. Field of the Invention

The present invention relates to a drill press, and more particularly to a drill press having an inspection structure.

2. Description of the Related Art

A conventional drill press in accordance with the prior art comprises a base, a column mounted on the base, a table mounted on a mediate portion of the column, a chuck mounted on an upper portion of the column and having a rotation shaft, a bit mounted on the chuck, a drive member mounted on the upper portion of the column for driving the rotation shaft of the chuck, a transmission unit mounted on the upper portion of the column and mounted between the chuck and the drive member to rotate the rotation shaft of the chuck, and a safety guard mounted on the upper portion of the column to cover the transmission unit. Thus, the transmission unit is driven by the drive member to rotate the rotation shaft of the chuck. In addition, the transmission unit includes a plurality of belt wheels to adjust the rotation speed of the rotation shaft of the chuck.

However, when an operator needs to replace the bit mounted on the chuck or to inspect the transmission unit, the operator has to detach and remove the safety guard to expose the transmission unit so as to judge and adjust the rotation speed of the rotation shaft of the chuck by inspecting the engaging conditions of the belt wheels of the transmission unit, thereby causing inconvenience to the operator. In addition, the operator needs to detach and remove the safety guard frequently, so that the safety guard is easily worn out during a long-term utilization, thereby decreasing the lifetime of the safety guard.

### SUMMARY OF THE INVENTION

The present invention is to mitigate and/or obviate the disadvantage of the conventional drill press.

The primary objective of the present invention is to provide a drill press having an inspection structure.

Another objective of the present invention is to provide a drill press, wherein an operator can view and inspect the transmission unit in the safety guard through the inspection structure to directly judge the rotation speed of the rotation shaft of the chuck by inspecting the engaging conditions of the belt wheels of the transmission unit without having to remove the safety guard to expose the transmission unit, thereby facilitating the operator manipulating the drill press and replacing the bits.

A further objective of the present invention is to provide a drill press, wherein the operator needs not to detach and remove the safety guard frequently so as to prevent the safety guard from being worn out during a long-term utilization, thereby enhancing the lifetime of the safety guard.

In accordance with the present invention, there is provided a drill press, comprising:
a column;
a transmission unit mounted on an upper portion of the column;
a safety guard mounted on the upper portion of the column to cover the transmission unit; and
an inspection structure mounted on a periphery of the safety guard and aligning with the transmission unit.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a drill press in accordance with the preferred embodiment of the present invention;

FIG. 2 is a partially enlarged exploded perspective view of the drill press as shown in FIG. 1;

FIG. 3 is a plan view of the drill press as shown in FIG. 2;

FIG. 4 is a partially enlarged cross-sectional view of the drill press as shown in FIG. 3;

FIG. 5 is a partially exploded perspective view of a drill press in accordance with another embodiment of the present invention; and

FIG. 6 is a partially exploded perspective view of a drill press in accordance with another embodiment of the present invention.

### DETAILED DESCRIPTION OF THE INVENTION

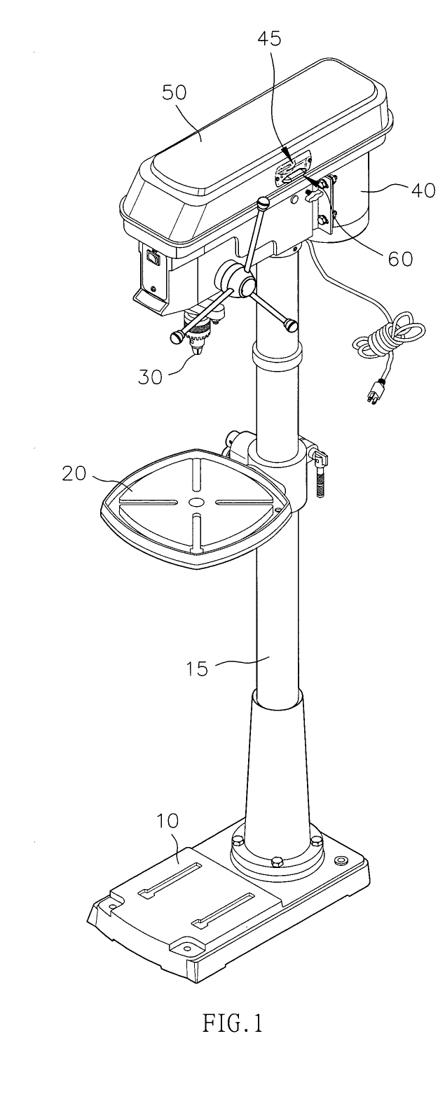

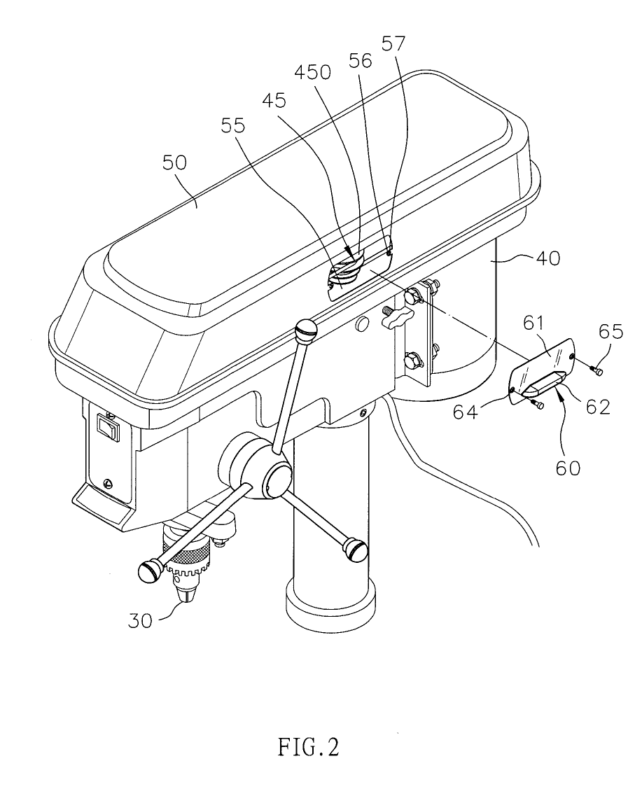

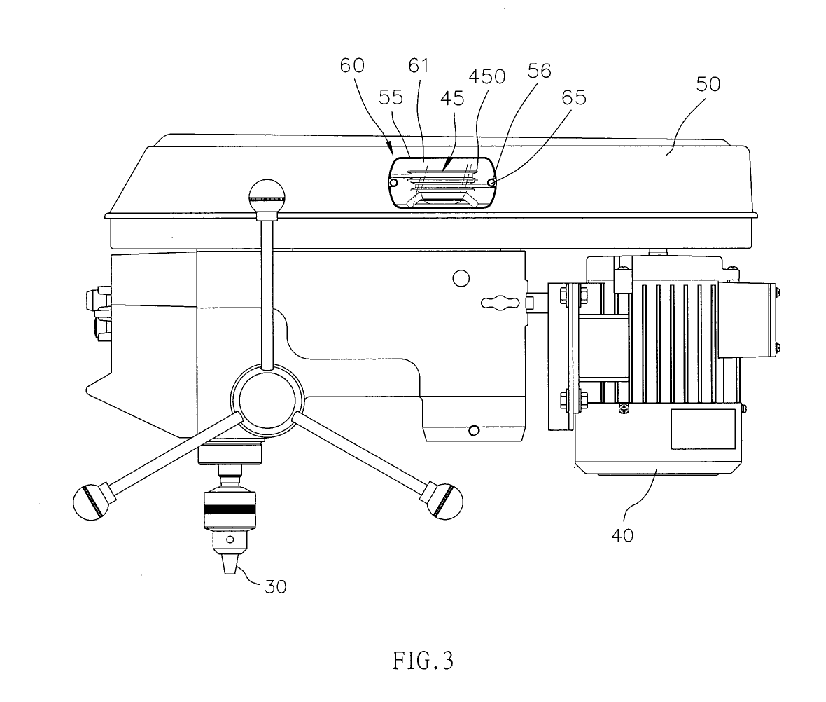

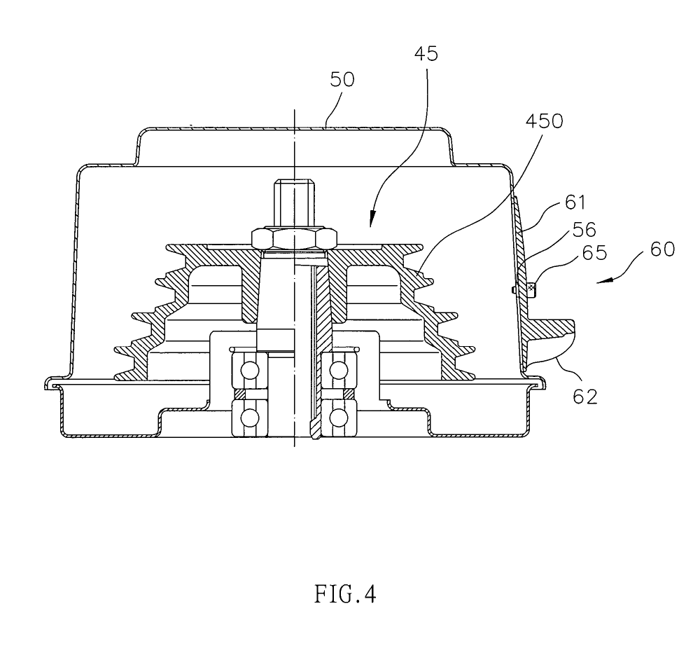

Referring to the drawings and initially to FIGS. 1-4, a drill press in accordance with the preferred embodiment of the present invention comprises a base 10, a column 15 mounted on the base 10, a work table 20 mounted on a mediate portion of the column 15, a chuck 30 mounted on an upper portion of the column 15 and having a rotation shaft (not shown), a bit (not shown) mounted on the chuck, a drive member 40 mounted on the upper portion of the column 15 for driving the rotation shaft of the chuck 30, a transmission unit 45 mounted on the upper portion of the column 15 and mounted between the chuck 30 and the drive member 40 to rotate the rotation shaft of the chuck 30, and a safety guard 50 mounted on the upper portion of the column 15 to cover the transmission unit 45. Thus, the transmission unit 45 is driven by the drive member 40 so as to rotate the rotation shaft of the chuck 30. In addition, the transmission unit 45 includes a plurality of belt wheels 450 to adjust the rotation speed of the rotation shaft of the chuck 30. The above-mentioned construction and operation of the drill press are conventional and will not be further described in detail.

The drill press further comprises an inspection structure 60 mounted on a periphery of the safety guard 50 and aligning with the transmission unit 45. Preferably, the periphery of the safety guard 50 is formed with a peep hole 55 aligning with the transmission unit 45, and the inspection structure 60 is mounted in the peep hole 55 of the safety guard 50. The inspection structure 60 includes a transparent plate 61 mounted in the peep hole 55 of the safety guard 50, and a handle 62 mounted on an outer face of the transparent plate 61 to facilitate a user holding the inspection unit 60. Preferably, the periphery of the safety guard 50 is formed with two opposite support ears 56 each extended into the peep hole 55 of the safety guard 50 and each formed with a screw bore 57, the transparent plate 61 of the inspection structure 60 has a periphery formed with two opposite through holes 64, and the inspection structure 60 further includes two locking bolts 65 each extended through a respective one of the two through holes 64 and each screwed into the screw bore 57 of a respective one of the two support ears 56 of the safety guard 50 to fix the transparent plate 61 of the inspection structure 60 on the safety guard 50.

Accordingly, when an operator needs to replace the bit (not shown) mounted on the chuck 30, the operator can view and inspect the transmission unit 45 in the safety guard 50 through the transparent plate 61 of the inspection structure 60 to directly judge and adjust the rotation speed of the rotation shaft of the chuck 30 by inspecting the engaging conditions of the belt wheels 450 of the transmission unit 45 without having to remove the safety guard 50 to expose the transmission unit 45, thereby facilitating the operator manipulating the drill press and replacing the bits. In addition, the operator needs not to detach and remove the safety guard 50 frequently so as to prevent the safety guard 50 from being worn out during a long-term utilization, thereby enhancing the lifetime of the safety guard 50.

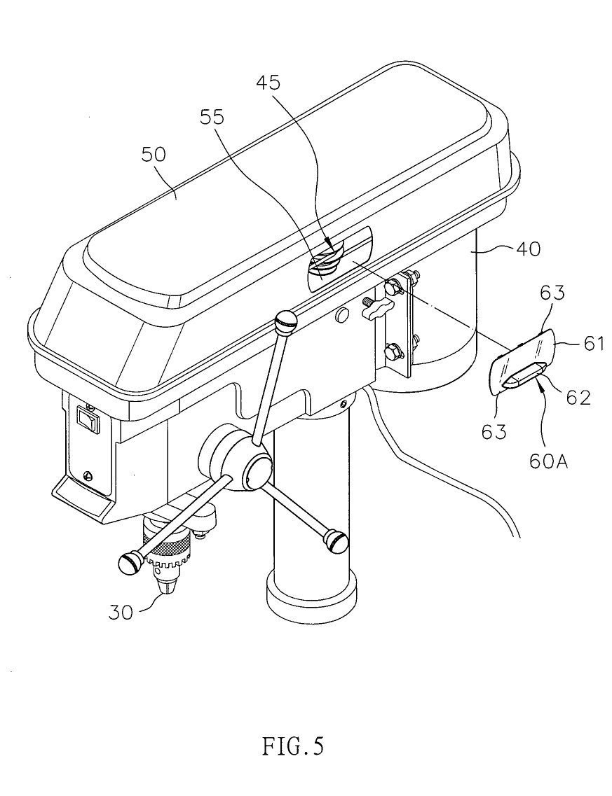

Referring to FIG. 5, the transparent plate 61 of the inspection structure 60A has a periphery formed with a plurality of snapping members 63 each snapped into the peep hole 55 of the safety guard 50 to fix the transparent plate 61 of the inspection structure 60 on the safety guard 50.

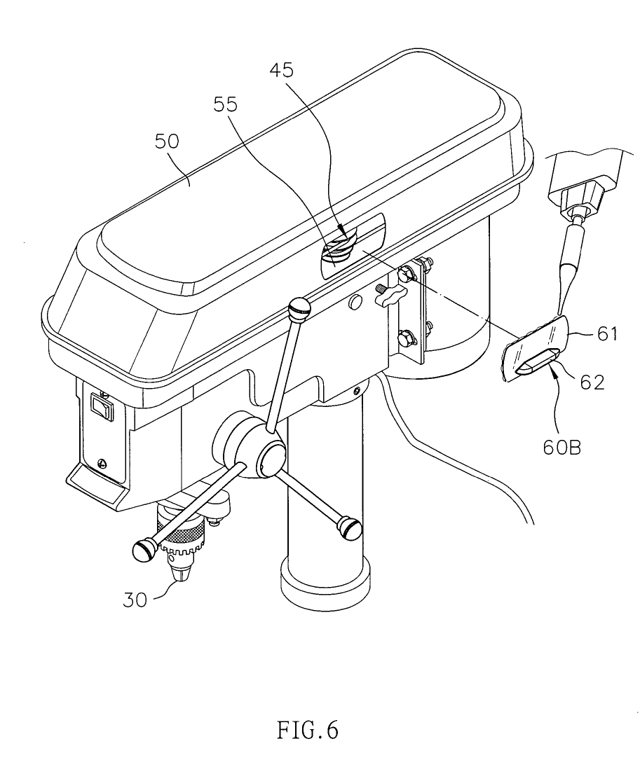

Referring to FIG. 6, the transparent plate 61 of the inspection structure 60B is bonded on a periphery of the peep hole 55 of the safety guard 50 by an adhesive to fix the transparent plate 61 of the inspection structure 60 on the safety guard 50.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A drill press, comprising:
a column;
a transmission unit mounted on an upper portion of the column;
a safety guard mounted on the upper portion of the column to cover the transmission unit; and
an inspection structure mounted on a periphery of the safety guard and aligning with the transmission unit.

2. The drill press in accordance with claim 1, wherein the periphery of the safety guard is formed with a peep hole aligning with the transmission unit, and the inspection structure is mounted in the peep hole of the safety guard.

3. The drill press in accordance with claim 2, wherein the inspection structure includes a transparent plate mounted in the peep hole of the safety guard.

4. The drill press in accordance with claim 3, wherein the inspection structure further includes a handle mounted on an outer face of the transparent plate.

5. The drill press in accordance with claim 3, wherein the periphery of the safety guard is formed with two opposite support ears each extended into the peep hole of the safety guard and each formed with a screw bore, the transparent plate of the inspection structure has a periphery formed with two opposite through holes, and the inspection structure further includes two locking bolts each extended through a respective one of the two through holes and each screwed into the screw bore of a respective one of the two support ears of the safety guard to fix the transparent plate of the inspection structure on the safety guard.

6. The drill press in accordance with claim 3, wherein the transparent plate of the inspection structure has a periphery formed with a plurality of snapping members each snapped into the peep hole of the safety guard to fix the transparent plate of the inspection structure on the safety guard.

7. The drill press in accordance with claim 3, wherein the transparent plate of the inspection structure is bonded on a periphery of the peep hole of the safety guard by an adhesive to fix the transparent plate of the inspection structure on the safety guard.
